(19) United States
(12) Patent Application Publication
(10) Pub. No.: US 2025/0383567 A1
(43) Pub. Date: Dec. 18, 2025

(54) ELECTROCHROMIC DEVICE AND METHOD OF MANUFACTURING THE SAME AND ELECTRONIC DEVICE

(71) Applicants: Samsung Electronics Co., Ltd., Suwon-si (KR); INDUSTRY-UNIVERSITY COOPERATION FOUNDATION HANYANG UNIVERSITY ERICA CAMPUS, Ansan-si (KR)

(72) Inventors: Won-Jae JOO, Suwon-si (KR); Caroline Sunyong LEE, Seoul (KR); Jiseon KIM, Seoul (KR); Sungjun CHOI, Seoul (KR); Minseok KIM, Seoul (KR)

(73) Assignees: Samsung Electronics Co., Ltd., Suwon-si (KR); INDUSTRY-UNIVERSITY COOPERATION FOUNDATION HANYANG UNIVERSITY ERICA CAMPUS, Ansan-si (KR)

(21) Appl. No.: 19/235,185

(22) Filed: Jun. 11, 2025

(30) Foreign Application Priority Data
Jun. 13, 2024 (KR) 10-2024-0077149

(51) Int. Cl. G02F 1/1523; G02F 1/1516; G02F 1/1524

(52) U.S. Cl. CPC G02F 1/1525; G02F 1/15165; G02F 1/1524

(57) ABSTRACT

Disclosed are an electrochromic device, a method for manufacturing the same, and an electronic device. The electrochromic device includes a first electrode, an electrochromic layer on the first electrode, an electrolyte on the electrochromic layer, and a second electrode on the electrolyte. The electrochromic layer includes inorganic nanoparticles having different particle size distributions along the thickness direction of the electrochromic layer, and a conductive polymer filling between the inorganic nanoparticles and covering an upper portion of the inorganic nanoparticles. A thickness of the conductive polymer covering the upper portion of the inorganic nanoparticles is less than about 10% of a total thickness of the electrochromic layer.

### CROSS-REFERENCE TO RELATED APPLICATION

This application claims priority to and the benefit of Korean Patent Application No. 10-2024-0077149 filed in the Korean Intellectual Property Office on Jun. 13, 2024, the entire contents of which are incorporated herein by reference.

### BACKGROUND

### 1. Field

The present inventive concepts relate to electrochromic devices, methods for manufacturing the same, and electronic devices.

### 2. Description of the Related Art

Electrochromism is a phenomenon in which a material reversibly changes color and/or opacity depending on the direction of an electric field at the material when a voltage is applied to the material. Electrochromic materials are materials whose optical properties may reversibly change through electrochemical oxidation and reduction reactions. In other words, an electrochromic material may have the property of not displaying color when an electric field is not applied to the material and displaying color when an electric field is applied material, or conversely, displaying color when no electric field is applied to the material and losing color (e.g., not displaying color) when an electric field is applied to the material.

Electrochromic materials may be applied to electrochromic devices that change their light transmission characteristics depending on applied voltage by utilizing these characteristics.

### SUMMARY

Some example embodiments provide an electrochromic device capable of improving reaction rate and color change efficiency, thereby improving operational performance and/or operational efficiency of the electrochromic device and any electronic device including same.

Some example embodiments provide a method for manufacturing the electrochromic device.

Some example embodiments provide an electronic device including the electrochromic device.

According to some example embodiments, an electrochromic device may include a first electrode, an electrochromic layer on the first electrode, an electrolyte on the electrochromic layer, and a second electrode on the electrolyte. The electrochromic layer may include inorganic nanoparticles having different particle size distributions along a thickness direction of the electrochromic layer, and a conductive polymer filling between the inorganic nanoparticles and covering n upper portion of the inorganic nanoparticles. A thickness of the conductive polymer covering the upper portion of the inorganic nanoparticles may be less than about 10% of a total thickness of the electrochromic layer.

The electrochromic layer may have a first surface proximate to the first electrode and distal from the electrolyte and a second surface proximate to the electrolyte and distal from the first electrode. A particle size of the inorganic nanoparticles may gradually increase from the first surface of the electrochromic layer to the second surface of the electrochromic layer.

The electrochromic layer may include a first region proximate to the first electrode and distal from the electrolyte and a second region proximate to the electrolyte and distal from the first electrode, such that the second region is between the first region and the electrolyte. The inorganic nanoparticles may include a first portion of inorganic nanoparticles in the first region and a second portion of inorganic nanoparticles in the second region. A particle size of the first portion of inorganic nanoparticles in the first region may be smaller than a particle size of the second portion of inorganic nanoparticles in the second region.

The electrochromic layer may include a polar solvent.

The polar solvent may include dimethyl sulfoxide (DMSO), dimethylformamide (DMF), acetonitrile, ethanol, methanol, propanol, butanol, ethylene glycol, acetone, 1,2-dichloroethane, or any combination thereof.

The polar solvent may be included in the electrochromic layer in an amount of about 0.001 wt % to about 1 wt % based on a total weight of the electrochromic layer. The inorganic nanoparticles may include tungsten oxide nanoparticles.

The conductive polymer may include PEDOT:PSS, polyaniline, polyacetylene, polypyrrole, polythiophene, polyparaphenylene, polyphenylenevinylene, polyfuran, a derivative thereof, or any combination thereof.

A thickness of the conductive polymer covering the upper portion of the inorganic nanoparticles may be less than about 30 nm.

The electrochromic device may further include an ion storage layer between the second electrode and the electrolyte, wherein the ion storage layer may include antimony-doped tin oxide.

According to some example embodiments, an electrochromic device may include a first electrode and a second electrode facing each other, an electrochromic layer between the first electrode and the second electrode and including a mixture of tungsten oxide nanoparticles and a conductive polymer, and an electrolyte between the electrochromic layer and the second electrode. The conductive polymer may include PEDOT:PSS, polyaniline, polyacetylene, polypyrrole, polythiophene, polyparaphenylene, polyphenylenevinylene, polyfuran, a derivative thereof, or any combination thereof, the electrochromic layer may have a first surface proximate to the first electrode and distal from the electrolyte and a second surface proximate to the electrolyte and distal from the first electrode. A particle size of the tungsten oxide nanoparticles may increase from the first surface of the electrochromic layer to the second surface of the electrochromic layer.

The electrochromic layer may further include a polar solvent including dimethyl sulfoxide (DMSO), dimethylformamide (DMF), acetonitrile, ethanol, methanol, propanol, butanol, ethylene glycol, acetone, 1,2-dichloroethane or any combination thereof, and the polar solvent may be included in the electrochromic layer in an amount of about 0.001 wt % to about 1 wt % based on a total weight of the electrochromic layer.

According to some example embodiments, a method of manufacturing an electrochromic device may include forming an electrochromic layer on a first electrode, disposing a second electrode to face the electrochromic layer, and supplying an electrolyte between the electrochromic layer and the second electrode. The forming of the electrochromic layer may include applying inorganic nanoparticles having different particle size distributions along a thickness direction on the first electrode, the thickness direction extending perpendicular to an upper surface of the first electrode, supplying a conductive polymer onto the inorganic nanoparticles to fill spaces between the inorganic nanoparticles and to coat on an upper portion of the inorganic nanoparticles, and rinsing the conductive polymer with a polar solvent to remove a portion of the conductive polymer that is on the upper portion of the inorganic nanoparticles.

The applying of the inorganic nanoparticles may include dry powder stacking the inorganic nanoparticles on the first electrode in a chamber.

The dry powder stacking the inorganic nanoparticles may include supersonically spraying the inorganic nanoparticles from a nozzle through a pressure difference between the chamber and a cartridge including the inorganic nanoparticles in a form of an aerosol powder, and a particle size of a first portion of the inorganic nanoparticles that are sprayed and stacked on the upper surface of the first electrode may be smaller than a particle size of a second portion of the inorganic nanoparticles that are sprayed and stacked on the first portion of the inorganic nanoparticles, subsequent to the spraying and stacking of the first portion of the inorganic nanoparticles.

The method may further include a first heat treatment subsequent to supplying the conductive polymer, and a second heat treatment subsequent to rinsing the conductive polymer with the polar solvent, wherein the first heat treatment and the second heat treatment may each independently be performed at about 80° C. to about 200° C.

The conductive polymer on the upper portion of the inorganic nanoparticles may have a first thickness subsequent to the first heat treatment and prior to the second heat treatment, and the conductive polymer on the upper portion of the inorganic nanoparticles may have a second thickness thinner than the first thickness subsequent to the second heat treatment.

The second thickness of the conductive polymer may be less than about 10% of a total thickness of the electrochromic layer.

Electrical conductivity of the electrochromic layer subsequent to the second heat treatment may be higher than electrical conductivity of the electrochromic layer subsequent to the first heat treatment and prior to the second heat treatment.

According to some example embodiments, an electronic device including the electrochromic device is provided.

The reaction rate and color change efficiency of an electrochromic device may be improved.

### BRIEF DESCRIPTION OF THE DRAWINGS

FIG. 1 is a cross-sectional view schematically showing an electrochromic device according to some example embodiments,

FIG. 2 is a schematic diagram showing an example of an electrochromic layer of the electrochromic device of FIG. 1 according to some example embodiments,

FIG. 3 is a graph showing the color change characteristics of an electrochromic device according to Example 1,

FIG. 4 is a graph showing the color change characteristics of an electrochromic device according to Comparative Example 1,

FIG. 5 is a graph showing the color change characteristics of an electrochromic device according to Comparative Example 2,

FIG. 6 is a graph showing the charge transfer resistance characteristics of an electrochromic layer in an electrochromic device according to Example 1.

FIG. 7 is a graph showing the charge transfer resistance characteristics of the electrochromic layer in the electrochromic device according to Comparative Example 1,

FIG. 8 is a graph showing the surface resistance characteristics of the electrochromic layer in the electrochromic device according to Example 1 and Comparative Example 1,

FIG. 9 is a schematic view of an electronic device according to some example embodiments, and

FIG. 10 is a flowchart illustrating a method according to some example embodiments.

### DETAILED DESCRIPTION

Hereinafter, some example embodiments of the present inventive concepts will be described in detail so that a person skilled in the art would understand the same. However, the inventive concepts may be embodied in many different forms and is not to be construed as limited to the example embodiments set forth herein.

To clearly describe the present inventive concepts, parts that are irrelevant to the description in the drawings are omitted. The same reference numerals are used for the same components in the drawings, and redundant descriptions thereof are omitted. Further, since sizes and thicknesses of constituent members shown in the accompanying drawings are arbitrarily given for better understanding and ease of description, the present inventive concepts are not limited to the illustrated sizes and thicknesses. In the drawings, the thickness of layers, films, panels, regions, etc., are exaggerated for clarity.

Throughout this specification and the claims that follow, when it is described that an element is “coupled/connected” to another element, the element may be “directly coupled/connected” to the other element or “indirectly coupled/connected” to the other element through a third element. In addition, unless explicitly described to the contrary, the word “comprise” and variations such as “comprises” or “comprising” will be understood to imply the inclusion of stated elements but not the exclusion of any other elements.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially perpendicular”, “substantially parallel”, or “substantially coplanar” with regard to other elements and/or properties thereof will be understood to be “perpendicular”, “parallel”, or “coplanar”, respectively, with regard to the other elements and/or properties thereof within manufacturing tolerances and/or material tolerances and/or have a deviation in magnitude and/or angle from “perpendicular”, “parallel”, or “coplanar”, respectively, with regard to the other elements and/or properties thereof that is equal to or less than 10% (e.g., a tolerance of ±10%).

It will be understood that surfaces which may be referred to as being “flat” may be understood to be “planar” or “substantially planar.” It will be understood that surfaces which may be referred to as being “planar” may be “planar” or may be “substantially planar.” Surfaces that are “substantially planar” will be understood to be “planar” within manufacturing tolerances and/or material tolerances and/or have surface portions with a deviation in magnitude and/or angle from “planar,” respectively, with regard to the other portions of the surfaces that is equal to or less than 10% (e.g., a tolerance of ±10%).

It will be understood that elements and/or properties thereof may be recited herein as being “identical”, “the same”, or “equal” as other elements and/or properties thereof, and it will be further understood that elements and/or properties thereof recited herein as being “identical” to, “the same” as, or “equal” to other elements and/or properties thereof may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to, equal to or substantially equal to, and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element or property is referred to as being identical to, equal to, or the same as another element or property, it should be understood that the element or property is the same as another element or property within a desired manufacturing or operational tolerance range (e.g., ±10%).

It will be understood that elements and/or properties thereof described herein as being “substantially” the same, equal, and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

It will be understood that when an element such as a layer, film, region, or substrate is referred to as being “on” another element, it may be directly on the other element or intervening elements may also be present. In contrast, when an element is referred to as being “directly on” another element, there are no intervening elements present. When an element is described as being “on” another element, the element may be above, beneath, or horizontally adjacent to the other element.

As used herein, when a definition is not otherwise provided, “substituted” refers to replacement of a hydrogen atom of a compound or a functional group by a substituent selected from a halogen atom, a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, silyl group, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C1 to C20 heteroalkyl group, a C3 to C20 heteroaryl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, and any combination thereof.

Hereinafter, “polymer” includes a homopolymer, a copolymer, or any combination thereof.

Hereinafter, the term “combination” includes a mixture, composite, or stacked structure of two or more.

The upper and lower relationship below is for better understanding and ease of explanation, but is not limited thereto.

An electrochromic device according to some example embodiments is described with reference to the drawing below.

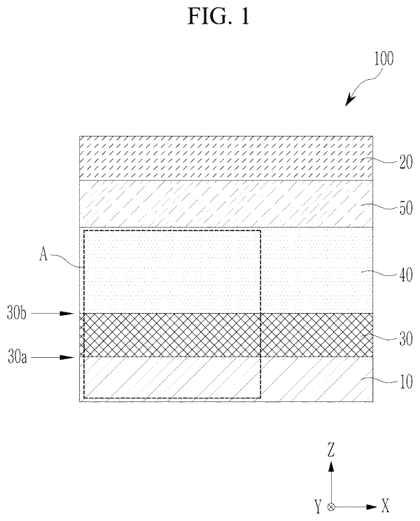

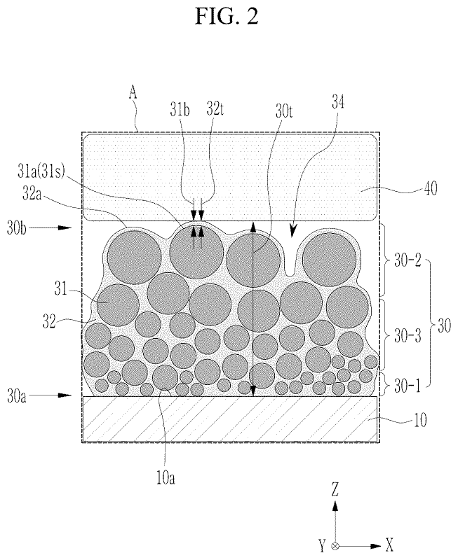

FIG. 1 is a cross-sectional view schematically showing an electrochromic device according to some example embodiments, and FIG. 2 is a schematic diagram showing an example of an electrochromic layer of the electrochromic device of FIG. 1 according to some example embodiments. FIG. 2 is a view of region A in FIG. 1.

Referring to FIG. 1, an electrochromic device 100 according to some example embodiments includes a first electrode 10, an electrochromic layer 30, an electrolyte 40, an ion storage layer 50, and a second electrode 20.

The first electrode 10 and the second electrode 20 may each be supported by a substrate (not shown), for example supported by separate, respective substrates, and the substrates may be fixed by a spacer (not shown) facing each other.

The substrate may be made of transparent glass or a polymer, and the polymer may include polyacrylate, polyethylene ether phthalate, polyethylene naphthalate, polycarbonate, polyarylate, polyether imide, polyether sulfone, polyimide, or any combination thereof, but is not limited thereto. Either of the substrates and the spacer may be omitted.

The first electrode 10 and the second electrode 20 are disposed to face each other. At least one of the first electrode 10 or the second electrode 20 may be made of a transparent conductor, and each of the first electrode 10 or the second electrode 20 may include an inorganic conductive material such as indium tin oxide (ITO), fluorine tin oxide (FTO), or antimony doped tin oxide (ATO), or an organic conductive material such as polyacetylene or polythiophene.

The electrochromic layer 30 may be on the first electrode 10 between the first electrode 10 and the second electrode 20. The electrochromic layer 30 may be in contact with the first electrode 10, for example, or may be located with an auxiliary layer (not shown) interposed therebetween. The auxiliary layer may be an adhesive auxiliary layer that increases the adhesion between the first electrode 10 and the electrochromic layer 30.

The electrochromic layer 30 includes an electrochromic material. The electrochromic material is a material that may be configured to reversibly display color or change color by electrochemical change along the direction of an electric field when voltage is applied to the electrochromic material (e.g., to the electrochromic layer 30), and the electrochromic material may include inorganic materials, organic materials, organic-inorganic materials, or any combination thereof.

The electrochromic material may be cathodic coloration materials or anodic coloration materials. The cathodic coloration material may be configured to display a color in a reduced state and become transparent in an oxidized state, and the anodic coloration material may be configured to display a color in an oxidized state and become transparent in a reduced state.

Referring to FIG. 2, the electrochromic layer 30 includes inorganic nanoparticles 31 and a conductive polymer 32. The inorganic nanoparticles 31 may be an inorganic electrochromic material and the conductive polymer 32 may be an organic electrochromic material, and thus the electrochromic layer 30 may include an organic-inorganic hybrid electrochromic material including both the inorganic electrochromic material and the organic electrochromic material.

The inorganic nanoparticles 31 may be, for example, semiconducting inorganic oxide nanoparticles, for example, tungsten oxide nanoparticles. The shape of each of the inorganic nanoparticles 31 may be various, such as sphere, tetrahedron, cylinder, triangle, disk, tripod, tetrapod, cube, box, star, and/or tube, and may be, for example, substantially spherical. The inorganic nanoparticles 31 may be in a crystalline state, an amorphous state, or a mixture of these, depending on the manufacturing method.

The inorganic nanoparticles 31 may be stacked along the thickness direction (e.g., Z direction) of the electrochromic layer 30 and may have different particle size distributions along the thickness direction of the electrochromic layer 30. For example, the electrochromic layer 30 may have a first surface 30a close to the first electrode 10 and a second surface 30b close to the electrolyte 40, and the particle size of the inorganic nanoparticles 31 in the electrochromic layer 30 may increase from the first surface 30a to the second surface 30b.

The particle size of the inorganic nanoparticles 31 in the electrochromic layer 30 may gradually increase from the first surface 30a to the second surface 30b, for example such that the particle size of the inorganic nanoparticles 31 in the electrochromic layer 30 may increase at a particular rate (e.g., a linear or substantially linear rate) and/or may increase as a function of distance from the first surface 30a and/or the first electrode 10. For example, a particle size of the inorganic nanoparticles 31 may increase from the first surface 30a of the electrochromic layer 30 to the second surface 30b of the electrochromic layer according to a relationship (e.g., a linear relationship, a nonlinear relationship, etc.) between particle size of the inorganic nanoparticles 31 and distance of the inorganic nanoparticles 31 from the first surface 30a in a thickness direction of the electrochromic layer 30 (e.g., the Z direction). Such a relationship may be a mathematical relationship. Such a relationship may include, for example, a linear relationship wherein the particle diameter is a function of the distance and a fixed constant (e.g., a nonzero real number). Such a relationship may include, for example, a linear relationship wherein the particle diameter is a function of the distance and a first fixed constant (e.g., a nonzero real number, which may define the slope of the function) and a second fixed constant (which may define the intercept of the function). For example, the particle size of inorganic nanoparticles 31 in the electrochromic layer may be proportional or substantially proportional (e.g., proportional or substantially proportional according to a fixed proportionality constant which may be a nonzero real number) to a distance of the inorganic nanoparticles from the first surface 30a in the thickness direction (e.g., Z direction) and/or from the first electrode 10 in the thickness direction (e.g., Z direction). However, in some example embodiments, the relationship between particle size of the inorganic nanoparticles 31 and distance of the inorganic nanoparticles 31 from the first surface 30a in the thickness direction of the electrochromic layer 30 may include, for example, a nonlinear relationship. In some example embodiments, the thickness direction (Z direction) may extend perpendicular or substantially perpendicular to an upper surface 10a of the first electrode 10, which may be contacted by the first surface 30a of the electrochromic layer 30. In some example embodiments, the particle size of the inorganic nanoparticles may increase in the thickness direction (e.g., Z direction) in step changes according to distance from the first surface 30a in the thickness direction, such that the electrochromic layer 30 may include separate regions at different distances or ranges of distances from the first surface 30a in the thickness direction (Z direction) and where inorganic nanoparticles 31 in the separate regions have different particle sizes.

Here, the particle size may be the diameter or longest diameter of the inorganic nanoparticles 31 or the average particle size (average diameter or average longest diameter) of the inorganic nanoparticles 31. The first surface 30a may be proximate to the first electrode 10 and distal from the electrolyte 40, and the second surface 30b may be proximate to the electrolyte 40 and distal from the first electrode 10. The first surface 30a may be adjacent to and/or in contact with the first electrode 10. The second surface 30b may be adjacent to and/or in contact with the electrolyte 40.

For example, the electrochromic layer 30 may include a first region 30-1 occupying a particular (or, alternatively, predetermined) thickness from the first surface 30a and a second region 30-2 occupying a particular (or, alternatively, predetermined) thickness from the second surface 30b, and the particle size of the inorganic nanoparticles 31 in the first region 30-1 may be smaller than the particle size of the inorganic nanoparticles 31 in the second region 30-2. The inorganic nanoparticles 31 may include a first portion of inorganic nanoparticles 31 in the first region 30-1 and a second portion of inorganic nanoparticles 31 in the second region 30-2, and a particle size (e.g., average particle size) of the first portion of inorganic nanoparticles 31 in the first region 30-1 is smaller than a particle size (e.g., average particle size) of the second portion of inorganic nanoparticles 31 in the second region 30-2.

For example, the average particle size of the inorganic nanoparticles 31 in the first region 30-1 (e.g., the first portion of the inorganic nanoparticles 31) may be about 1 nm to about 500 nm, and within the above range may be about 1 nm to about 300 nm, about 1 nm to about 200 nm, about 1 nm to about 100 nm, about 1 nm to about 80 nm, about 1 nm to about 50 nm, or about 1 nm to about 30 nm.

For example, the average particle size of the inorganic nanoparticles 31 in the second region 30-2 (e.g., the second portion of the inorganic nanoparticles 31) may be larger than the average particle size of the inorganic nanoparticles 31 in the first region 30-1, and may be, for example, greater than about 100 nm and less than about 800 nm, and within the above range may be about 200 nm to about 800 nm, about 300 nm to about 800 nm, or about 400 nm to about 800 nm.

For example, the electrochromic layer 30 may include a first region 30-1 occupying a particular (or, alternatively, predetermined) thickness from the first surface 30a, a second region 30-2 occupying a particular (or, alternatively, predetermined) thickness from the second surface 30b, and a third region 30-3 between the first region 30-1 and the second region 30-2, and the particle size of the inorganic nanoparticles 31 in the first region 30-1 (e.g., a first portion of the inorganic nanoparticles 31) may be smaller than the particle size of the inorganic nanoparticles 31 in the third region 30-3 (e.g., a third portion of the inorganic nanoparticles 31), and the particle size of the inorganic nanoparticles 31 in the third region 30-3 may be smaller than the particle size of the inorganic nanoparticles 31 in the second region 30-2 (e.g., a second portion of the inorganic nanoparticles 31). The average particle size of the inorganic nanoparticles 31 in the third region 30-3 may be between the average particle size of the inorganic nanoparticles 31 in the first region 30-1 and the average particle size of the inorganic nanoparticles 31 in the second region 30-2.

The particle size distribution of the inorganic nanoparticles 31 may be implemented by the dry powder stacking method described later, and as described later, the inorganic nanoparticles 31 in the form of aerosol powder are sprayed supersonically onto the first electrode 10, so that the particle size of the inorganic nanoparticles 31 sprayed first and stacked may be smaller than the particle size of the inorganic nanoparticles 31 sprayed later and stacked, and the particle size of the stacked particles may be larger depending on the spraying order. This will be described later.

In this way, the inorganic nanoparticles 31 (e.g., inorganic nanoparticles included in the first region 30-1) close to the first electrode 10 (e.g., in contact with the first electrode 10) have relatively small particle sizes, thereby increasing adhesion to the first electrode 10 and thus enhancing electrical characteristics, while the inorganic nanoparticles 31 (e.g., inorganic nanoparticles included in the second region 30-2) close to the electrolyte 40 (e.g., in contact with the electrolyte 40) have relatively large particle sizes (e.g., larger particle sizes than the inorganic nanoparticles close to and/or in contact with the first electrode 10), thereby increasing a porosity of the electrochromic layer 30 and thus sufficiently securing an ionic path from the electrolyte 40. In some example embodiments, the electrochromic device 100 may be configured to change color and/or opacity in response to an applied electric field and/or applied voltage with improved reaction rate and/or color change efficiency, such that the electrochromic device 100 may exhibit improved electrochromic operational performance and/or efficiency (e.g., improved power consumption efficiency without compromising electrochromic operational performance), based on the different particle size distributions of the inorganic nanoparticles 31 along the thickness direction (Z direction) of the electrochromic layer 30 (e.g., based on particle sizes of the inorganic nanoparticles 31, including for example average particle sizes thereof, changing along the thickness direction (Z direction) in the electrochromic layer 30).

The conductive polymer 32 may fill the spaces between the inorganic nanoparticles 31 and cover the upper portion 31a of the inorganic nanoparticles 31 (e.g., upper surfaces 31s of the uppermost inorganic nanoparticles 31 that are exposed in at least the thickness direction from the inorganic nanoparticles in the electrochromic layer 30). The conductive polymer 32 may surround the entire surface of the inorganic nanoparticles 31 and may be between adjacent inorganic nanoparticles 31 to provide a charge transfer path between the inorganic nanoparticles 31.

The conductive polymer 32 is not particularly limited as long as it is a polymer that is conductive and may electrochemically react with the electrolyte 40, and may include, for example, poly(3,4-ethylenedioxythiophene):polystyrenesulfonate (PEDOT:PSS), polyaniline, polyacetylene, polypyrrole, polythiophene, polyparaphenylene, polyphenylenevinylene, polyfuran, a derivative thereof, or any combination thereof, but is not limited thereto. For example, the conductive polymer 32 may include PEDOT:PSS.

As used herein, “PEDOT:PSS or a derivative thereof” refers to poly(3,4-ethylenedioxythiophene) polystyrenesulfonate as well as a structural or a chemical group modification of the polymer poly(3,4-ethylenedioxythiophene)-polystyrenesulfonate, for example, including one or more group substituents (as defined herein) on the ethylene, thiophene, or styrene moieties of the polymer, a doping of the poly(3,4-ethylenedioxythiophene) polystyrenesulfonate with another material element, compound, material, or polymer, or a grafting of a second polymer to the poly(3,4-ethylenedioxythiophene) polystyrenesulfonate.

A thickness 32t of the conductive polymer 32 covering an upper portion 31a of the inorganic nanoparticles 31 may be relatively thin, for example, less than about 10% of the total thickness 30t of the electrochromic layer 30 between the first surface 30a and the second surface 30b in the thickness direction (Z direction), for example about 0.1% to about 10%, about 0.3% to about 10%, about 1% to about 10%, about 3.3% to about 10%, about 5.0% to about 10%, about 6.7% to about 10%, or about 8.3% to about 10%, although example embodiments are not limited thereto.

For example, the total thickness 30t of the electrochromic layer 30 may be greater than or equal to about 50 nm and less than about 300 nm, and the thickness 32t of the conductive polymer 32 covering the upper portion 31a of the inorganic nanoparticles 31 may be less than about 30 nm, and within the above range may be less than or equal to about 25 nm, less than or equal to about 20 nm, less than or equal to about 15 nm, or less than or equal to about 10 nm, and within the above range may be greater than or equal to about 1 nm and less than about 30 nm, about 1 nm to about 25 nm, about 1 nm to about 20 nm, about 1 nm to about 15 nm, about 1 nm to about 10 nm, greater than or equal to about 3 nm and less than about 30 nm, about 3 nm to about 25 nm, about 3 nm to about 20 nm, about 3 nm to about 15 nm, or about 3 nm to about 10 nm, although example embodiments are not limited thereto.

As described below, the relatively thin thickness 32t of the conductive polymer 32 covering the upper portion 31a of the inorganic nanoparticles 31 may be implemented by additionally performing a rinsing process using a solvent after coating the conductive polymer 32 (e.g., coating the conductive polymer 32 on and/or between the inorganic nanoparticles 31). The rinsing process using a solvent may physically and chemically remove a portion of the conductive polymer 32 covering the upper portion 31a of the inorganic nanoparticles 31. For example, when PEDOT:PSS is included as a conductive polymer 32, the solvent may effectively separate dielectric polystyrene sulfonate (PSS) from poly(3,4-ethylenedioxythiophene) (PEDOT), thereby increasing the linearity of the PEDOT chain structure and further increasing the electrical conductivity.

In this way, since the conductive polymer 32 covering the upper portion 31a of the inorganic nanoparticles 31 has a relatively thin thickness 32t, the gap 31b between the inorganic nanoparticles 31 and the electrolyte 40 is narrowed, so that the ion transfer path from the electrolyte 40 to the inorganic nanoparticles 31 is shortened, thereby increasing the electrochemical reaction rate. In some example embodiments, the electrochromic device 100 may be configured to change color and/or opacity in response to an applied electric field and/or applied voltage with improved reaction rate and/or color change efficiency, such that the electrochromic device 100 may exhibit improved electrochromic operational performance and/or efficiency (e.g., improved power consumption efficiency without compromising electrochromic operational performance), based on the electrochromic layer 30 including a conductive polymer filling between the inorganic nanoparticles 31 and covering the upper portion 31a of the inorganic nanoparticles and where the thickness 32t of the conductive polymer covering the upper portion 31a of the inorganic nanoparticles 31 is relatively thin, for example less than about 10% of the total thickness 30t of the electrochromic layer 30, for example about 0.1% to about 10% of the total thickness 30t of the electrochromic layer 30.

The solvent used in such rinsing process may be a polar solvent, such as dimethyl sulfoxide (DMSO), dimethylformamide (DMF), acetonitrile, ethanol, methanol, propanol, butanol, ethylene glycol, acetone, 1,2-dichloroethane, or any combination thereof, but is not limited thereto.

At least a portion of the solvent used in the rinsing process may remain in the electrochromic layer 30, and for example, since the solvent is supplied from the upper portion of the electrochromic layer 30 in the rinsing process, the remaining solvent may be included more in the upper portion of the electrochromic layer 30 (e.g., on the electrolyte 40 side), and for example, may be included more in the second region 30-2 relatively close to the electrolyte 40.

The remaining solvent may be included in the electrochromic layer 30 in an amount of less than or equal to about 1 wt %, and within the above range, for example, about 0.001 to about 1 wt %, about 0.001 to about 0.8 wt %, about 0.001 to about 0.5 wt %, about 0.01 to about 1 wt %, about 0.01 to about 0.8 wt %, or about 0.01 to about 0.5 wt % based on the total weight of the electrochromic layer 30.

In this way, the electrochromic layer 30 may have a particle size distribution of inorganic nanoparticles 31 along the thickness direction (e.g., Z direction) of the electrochromic layer 30, thereby increasing adhesion to the first electrode 10 and at the same time sufficiently securing an ion path from the electrolyte 40, thereby simultaneously improving electrical characteristics and electrochemical reactions. In addition, the electrochromic layer 30 may further improve electrical characteristics by further including a conductive polymer 32 filling between the inorganic nanoparticles 31, thereby filling the gap between adjacent inorganic nanoparticles 31 and providing an effective charge transfer path, and at the same time, by removing at least a portion of the conductive polymer 32 covering the upper portion 31a of the inorganic nanoparticles 31 through a rinsing process, only a relatively thin conductive polymer 32 having a relatively thin thickness 32t remains between the electrolyte 40 and the inorganic nanoparticles 31, thereby further increasing the electrical conductivity and the electrochemical reaction rate. In some example embodiments, the electrochromic device 100 may be configured to change color and/or opacity in response to an applied electric field and/or applied voltage with improved reaction rate and/or color change efficiency, such that the electrochromic device 100 may exhibit improved electrochromic operational performance and/or efficiency (e.g., improved power consumption efficiency without compromising electrochromic operational performance), based on the electrochromic layer 30 including a conductive polymer filling between the inorganic nanoparticles 31 and covering the upper portion 31a of the inorganic nanoparticles and where the thickness 32t of the conductive polymer between (e.g., directly between) the upper portion 31a of the inorganic nanoparticles 31 and the electrolyte 40) is relatively thin, for example less than about 10% of the total thickness 30t of the electrochromic layer 30, for example about 0.1% to about 10% of the total thickness 30t of the electrochromic layer 30.

A content ratio of inorganic nanoparticles 31 and conductive polymer 32 within the electrochromic layer 30 may be about 1:2 to about 1:10 (weight ratio), and within the range of about 1:2.5 to about 1:9 or about 1:3 to about 1:8, but is not limited thereto.

The electrolyte 40 (also referred to herein interchangeably as an electrolyte layer 40) may be filled between the second electrode 20 and the electrochromic layer 30 (or between the ion storage layer 50 and the electrochromic layer 30) and may be in contact with the electrochromic layer 30.

The electrolyte 40 may supply (e.g., may include) a substance that promotes an oxidation/reduction reaction of the electrochromic material, and may include a liquid electrolyte or a solid polymer electrolyte, and the liquid electrolyte or the solid polymer electrolyte may be an ionic material. The ionic liquid electrolyte may include a base electrolyte including, for example, a metal salt and a polymer, wherein the metal salt may be for example a lithium salt such as LiOH, LiClO₄, LiBF₄, LiASF₆, LiPF₆, or any combination thereof, a potassium salt such as KOH, a sodium salt such as NaOH, or any combination thereof and the polymer may be, for example, but not limited to, PVdF (poly(vinyl fluoride)), PMMA (poly(methyl methacrylate)), PVC (poly(vinyl chloride)), PEO (poly(ethylene oxide)), PAN (polyacrylonitrile), PDMS (poly(dimethylsiloxane)), PPO (poly(propylene oxide)), PMEP (poly[bis(methoxyethoxyehox-ide)-phosphazane]), PVdF-HFP (poly(vinylidene fluoridehexafluoropropylene)), or any combination thereof, but is not limited thereto. Examples of the ionic solid electrolyte that may be used may include poly(2-acrylamino-2-methylpropane sulfonic acid), poly(ethylene oxide), 1-butyl-3-methylimidazolium bis(trifluoromethylsulfonyl)imide (BMIMTFSI), and/or 1-butyl-3-methylimidazolium tetrafluoroborate (BMIMMBF4), but are not limited thereto.

As shown in FIG. 2, the vertical level of the upper surface 32a of the conductive polymer 32 having a thin thickness 32t on the upper portion 31a of the inorganic nanoparticles 31 may vary, such that a region 34 may be defined between the vertical level (e.g., in the thickness direction, for example a distance from the first surface 30a in the thickness direction) of the uppermost portion of the upper surface 32a of the conductive polymer 32 covering the uppermost upper portion 31a of the inorganic nanoparticles 31 and the vertical level (e.g., in the thickness direction, for example a distance from the first surface 30a in the thickness direction) of other portions of the upper surface 32a of the conductive polymer 32. As shown, the vertical level of the of the uppermost portion of the upper surface 32a of the conductive polymer 32 covering the uppermost upper portion 31a of the inorganic nanoparticles 31 may define the vertical level of the second surface 30b of the electrochromic layer 30. In some example embodiments, the region between the vertical level of the second surface 30b and the upper surface 32a of the conductive polymer 32 may be filled by electrolyte 40, for example such that region 34 as shown in FIG. 2 may be partially or entirely filled and/or occupied by electrolyte 40 contacting some or all of the upper surface 32a of the conductive polymer 32. As a result, in some example embodiments the second surface 30b of the electrochromic layer 30 may be a nonplanar surface defined by the upper surface 32a of the conductive polymer 32 contacting the electrolyte 40 and where the vertical level of the upper surface 32a (and thus the vertical level of the second surface 30b) in the thickness direction varies over the area of the electrochromic layer 30 in the xy direction. In some example embodiments, region 34 may be filled and/or occupied by one or more additional materials, including for example excess conductive polymer 32 and/or electrolyte 40.

The ion storage layer 50 may be included to balance the charge with the electrochromic layer 30 during the redox reaction of the electrochromic layer 30, and may include, for example, an electrochromic material having different coloring characteristics from the electrochromic layer 30, or may include, for example, an electrochromic material having coloring characteristics complementary to the electrochromic layer 30. The ion storage layer 50 may include, for example, antimony-doped tin oxide. The ion storage layer 50 may be omitted in some example embodiments.

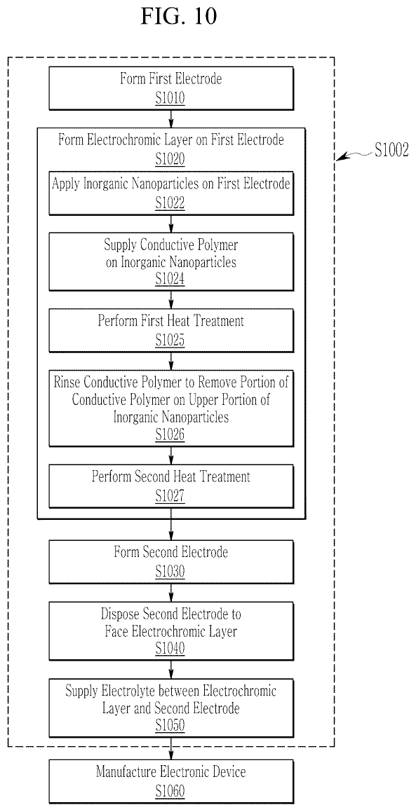

FIG. 10 is a flowchart illustrating a method according to some example embodiments. The method may include a method S1002 for manufacturing an electrochromic device. Referring to FIG. 10, an example of a method for manufacturing the aforementioned electrochromic device 100 at S1002 is described with reference to FIGS. 1 and 2. However, it will be understood that the method at S1002 may be performed to manufacture electrochromic devices according to other example embodiments, and the operations shown in FIG. 10 may be rearranged in relation to the order shown in FIG. 10. One or more operations shown in FIG. 10 may be omitted. One or more operations may be added to the method shown in FIG. 10.

A method for forming an electrochromic device 100 at S1002 according to some example embodiments (e.g., a method for forming the electrochromic device 100 as shown in FIG. 1 and further shown in FIG. 2) may include forming a first electrode 10 (S1010), for example forming the first electrode 10 on a substrate (not shown), forming an electrochromic layer 30 on the first electrode 10 (S1020), forming a second electrode 20 (and in some example embodiments, an ion storage layer 50) (S1030), for example forming the second electrode 20 on another substrate (not shown), disposing the electrochromic layer 30 and the second electrode 20 (or the ion storage layer 50) to face each other (S1040), sealing the two substrates using a spacer (not shown), and supplying an electrolyte therebetween (S1050). It will be understood that at least some of the operations (e.g., operations S1010, S1025, S1027, S1030, S1060 etc.) may be omitted from the method shown in FIG. 10.

The forming of the electrochromic layer 30 at S1020 may include applying inorganic nanoparticles 31 on a first electrode 10 (S1022), supplying a conductive polymer 32 to the inorganic nanoparticles 31 (S1024) (e.g., coating the conductive polymer 32 on and/or between the inorganic nanoparticles 31), and rinsing the conductive polymer 32 with a polar solvent (S1026).

The inorganic nanoparticles 31 may be applied (at S1022) by a dry process, which may include, for example, dry powder stacking inorganic nanoparticles 31 on a first electrode 10 in a chamber. The dry powder stacking of the inorganic nanoparticles 31 may include, at S1022, supersonically spraying the inorganic nanoparticles 31 from a nozzle through a pressure difference between a chamber and a cartridge including the inorganic nanoparticles in the form of an aerosol powder.

Specifically, the powder for forming inorganic nanoparticles 31 may be obtained by mechanically grinding an inorganic oxide such as a metal oxide, forming the grinded inorganic nanoparticles into aggregates of a particular (or, alternatively, predetermined) size by a spray dryer, and firing the aggregates.

The inorganic oxide may be, for example, tungsten oxide, and mechanical grinding may be performed, for example, by ball milling.

The size of the aggregates may be determined depending on the spray drying conditions and may have a size (diameter, average diameter, etc.) of, for example, about 1 μm to about 5 μm.

The firing may be performed at a high temperature of about 500° C. to about 800° C., for example, in a hydrogen atmosphere, and the aggregates may be fired and deformed into a network structure.

The fired aggregates may be used as a source powder in the dry powder stacking inorganic nanoparticles 31 on the first electrode 10 (e.g., on the upper surface 10a thereof).

The source powder including the fired aggregates may be placed in a cartridge, and the cartridge may be connected to a chamber equipped with a substrate on which a first electrode 10 is formed. The aggregates, which are fired by the pressure difference between the chamber and the cartridge, may be accelerated supersonically on the first electrode 10 and sprayed into the chamber at S1022, for example through a nozzle. The chamber may be, for example, an air atmosphere (e.g., a chamber having an interior pressure that is equal or substantially equal to ambient atmospheric pressure (e.g., 1 atm)).

The fired aggregate (source powder) sprayed onto the first electrode 10 at S1022 may be destroyed by colliding with the surface (e.g., an exposed upper surface 10a) of the first electrode 10 by supersonic acceleration, and thus may be split into inorganic nanoparticles 31 of a smaller size than the aggregate. Accordingly, the particle size of the inorganic nanoparticles 31 stacked directly on the first electrode 10 (e.g., directly on and/or contacting the upper surface 10a) may be much smaller than the aggregates, and for example, may be about 1 nm to about 500 nm, and within the above range may be about 1 nm to about 300 nm, about 1 nm to about 200 nm, about 1 nm to about 100 nm, about 1 nm to about 80 nm, about 1 nm to about 50 nm, or about 1 nm to about 30 nm. The inorganic nanoparticles 31 that are directly on the first electrode 10 may be referred to herein as the first portion of the inorganic nanoparticles 31, the lowermost inorganic nanoparticles 31, or the like.

The continuously sprayed fired aggregates (source powder) may be sequentially stacked on inorganic nanoparticles 31 at S1022, and may be destroyed by colliding with the inorganic nanoparticles 31 located underneath, thereby being split into inorganic nanoparticles 31 (which may be referred to herein as a second portion of the inorganic nanoparticles 31) of a smaller size than the aggregates. However, the inorganic nanoparticles 31 (e.g., the second portion of the inorganic nanoparticles 31) stacked on the inorganic nanoparticles 31 that are stacked directly on or are closer to the first electrode 10 (e.g., the first portion of the inorganic nanoparticles 31) may have a weaker collision force than the inorganic nanoparticles 31 that collide directly with the surface (e.g., upper surface 10a) of the first electrode 10, and thus the destructive force of the aggregate may be weaker, and accordingly, the inorganic nanoparticles 31 stacked on the inorganic nanoparticles 31 at S1022 may be stacked with a larger particle size than the inorganic nanoparticles 31 stacked directly on the first electrode 10. For example, a particle size (e.g., average particle size, average particle diameter, etc.) of a first portion of the inorganic nanoparticles 31 that are sprayed and stacked on the upper surface 10a of the first electrode 10 may be smaller than a particle size of a second portion of the inorganic nanoparticles 31 that are sprayed and stacked on the first portion of the inorganic nanoparticles 31, subsequent to the spraying and stacking of the first portion of the inorganic nanoparticles 31. Accordingly, as illustrated in FIG. 2, the particle size distribution of the inorganic nanoparticles 31 in the electrochromic layer 30 may vary from the area in contact with the surface of the first electrode 10 along the thickness direction (e.g., Z direction, which may extend perpendicular or substantially perpendicular to the upper surface 10a of the first electrode 10), and for example, the particle size of the inorganic nanoparticles 31 may increase (e.g., gradually increase) from the first surface 30a of the electrochromic layer 30 close to the first electrode 10 to the second surface 30b (the surface close to the electrolyte 40) which is the uppermost surface of the electrochromic layer 30.

At S1024, a conductive polymer 32 may be supplied on the inorganic nanoparticles 31 obtained through a solution process. The conductive polymer 32 may include, for example, PEDOT:PSS, polyaniline, polyacetylene, polypyrrole, polythiophene, polyparaphenylene, polyphenylenevinylene, polyfuran, derivatives thereof, or any combination thereof, and may be, for example, PEDOT:PSS. The solution processes may include, but are not limited to, spin coating, slit coating, inkjet coating, or dip coating.

Subsequently (e.g., in response to the supplying of the conductive polymer 32 on and/or between the inorganic nanoparticles 31), at S1025 a first heat treatment (e.g., a first heat treatment of at least the conductive polymer 32 and inorganic nanoparticles 31 on the first electrode 10) may be performed. The first heat treatment may be performed, for example, at about 80° C. to 200° C. for about 5 minutes to about 3 hours, and within the above range, may be performed at about 90° C. to about 180° C., about 100° C. to about 160° C., or about 110° C. to about 150° C. for about 5 minutes to 3 hours. It will be understood that such heat treatment may include heating the chamber in which at least the conductive polymer 32 and inorganic nanoparticles 31 on the first electrode 10 is located to the aforementioned temperature(s) for the aforementioned period(s) of time. By the first heat treatment, the remaining solvent in the conductive polymer 32 is effectively removed, and the conductive polymer 32 may effectively fill the spaces between the inorganic nanoparticles 31 and be applied to a particular (or, alternatively, predetermined) thickness on the upper portion 31a of the inorganic nanoparticles 31 to form a coated conductive polymer 32.

Subsequently, at S1026 the conductive polymer 32 (e.g., the coated conductive polymer 32) is rinsed with a solvent. The solvent may be, for example, a polar solvent, including dimethyl sulfoxide (DMSO), dimethylformamide (DMF), acetonitrile, ethanol, methanol, propanol, butanol, ethylene glycol, acetone, 1,2-dichloroethane, or any combination thereof, but is not limited thereto.

Subsequently (e.g., in response to the rinsing of the conductive polymer 32 with the polar solvent), at S1027 a second heat treatment may be performed. The second heat treatment may be performed, for example, at about 80° C. to about 200° C. for about 5 minutes to about 3 hours, and within the above range, may be performed at about 90° C. to about 180° C., about 100° C. to about 160° C., or about 110° C. to about 150° C. for about 5 minutes to about 3 hours. It will be understood that such heat treatment may include heating the chamber in which at least the conductive polymer 32 and inorganic nanoparticles 31 on the first electrode 10 is located to the aforementioned temperature(s) for the aforementioned period(s) of time.

In this way, by rinsing the conductive polymer 32 with a solvent and performing a second heat treatment, a portion of the conductive polymer 32 applied to a particular (or, alternatively, predetermined) thickness on the upper portion 31a of the inorganic nanoparticles 31 may be removed. For example, when the conductive polymer 32 formed on the inorganic nanoparticles 31 before the solvent rinsing step (after the first heat treatment step) has a first thickness, the conductive polymer 32 formed on the inorganic nanoparticles 31 after the solvent rinsing and second heat treatment step may have a second thickness thinner than the first thickness, and for example, the second thickness, which is the final thickness 32t of the conductive polymer 32 formed on the inorganic nanoparticles 31, may be less than about 10% of the total thickness 30t of the electrochromic layer 30, and may be less than about 30 nm, and within the above range may be less than or equal to about 25 nm, less than or equal to about 20 nm, less than or equal to about 15 nm, or less than or equal to about 10 nm, and within the above range may be greater than or equal to about 1 nm and less than about 30 nm, about 1 nm to about 25 nm, about 1 nm to about 20 nm, about 1 nm to about 15 nm, about 1 nm to about 10 nm, or greater than or equal to about 3 nm and less than about 30 nm, about 3 nm to about 25 nm, about 3 nm to about 20 nm, about 3 nm to about 15 nm, or about 3 nm to about 10 nm of the total thickness of the electrochromic layer 30.

In this way, by rinsing the conductive polymer 32 with a solvent and performing a second heat treatment, at least a portion of the conductive polymer 32 formed on the inorganic nanoparticles 31 may be physically and chemically removed, and accordingly, the gap 31b between the inorganic nanoparticles 31 and the electrolyte 40 is narrowed, thereby shortening the ion transfer path from the electrolyte 40 to the inorganic nanoparticles 31, thereby increasing the electrochemical reaction rate. For example, the electrical conductivity of the electrochromic layer 30 after the rinsing of the conductive polymer 32 with a solvent and performing the second heat treatment may be higher than the electrical conductivity of the electrochromic layer 30 before the rinsing of the conductive polymer 32 with a solvent (after performing the first heat treatment), and for example, an electrical conductivity improvement effect of greater than or equal to about 10%, greater than or equal to about 15%, greater than or equal to about 20%, greater than or equal to about 25%, greater than or equal to about 30%, about 10% to about 100%, about 15% to about 100%, about 20% to about 100%, about 25% to about 100%, or about 30% to about 100% may be obtained. In some example embodiments, the electrochromic device 100 may be configured to change color and/or opacity in response to an applied electric field and/or applied voltage with improved reaction rate and/or color change efficiency, such that the electrochromic device 100 may exhibit improved electrochromic operational performance and/or efficiency (e.g., improved power consumption efficiency without compromising electrochromic operational performance), based on the electrochromic layer 30 exhibiting the increased electrical conductivity and/or shortened ion transfer path due at least in part to the reduced thickness 32t of the conductive polymer 32 on the upper portion 31a of the inorganic nanoparticles 31 and/or the reduced gap 31b between the inorganic nanoparticles 31 and the electrolyte 40.

In some example embodiments, one or both of the first heat treatment at S1025 and/or the second heat treatment at S1027 may be omitted from the method shown in FIG. 10.

The forming of the ion storage layer 50 (e.g., at S1030) may be applied as a solution process or a dry process, and for example, may be applied as a dry process. The dry process may include, for example, dry powder stacking, for example, antimony-doped tin oxide (ATO) powders onto a second electrode 20 in a chamber (e.g., at S1040), and the dry powder stacking the ATO powders may include supersonically spraying the ATO particles from a nozzle through a pressure difference between the chamber and a cartridge including the ATO particles in aerosol powder form. The specific method may be the same as the dry powder stacking method described above.

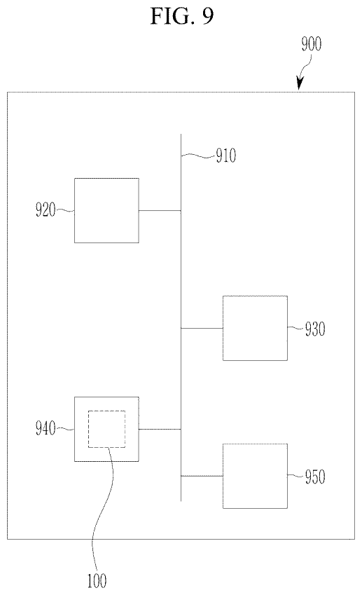

The aforementioned electrochromic device may be applied to various electronic devices that utilize control of the inflow of light through color control, such as optical filters, electronic signboards, smart windows, or wearable imaging devices (such as an augmented reality (AR) or a virtual reality (VR)). As shown in FIG. 10, the method may include manufacturing an electronic device at S1060 which may include incorporating the electrochromic device manufactured at S1002 into a manufactured electronic device, the electronic device manufactured at S1060 may include the electronic device 900 shown in FIG. 9. The electronic device manufactured at S1060 may include optical filters, electronic signboards, smart windows, or wearable imaging devices (such as an augmented reality (AR) or a virtual reality (VR)). The manufacturing at S1060 may include assembling the electronic device which may further include mounting the electrochromic device manufactured at S1002 into and/or onto a structure of the electronic device.

FIG. 9 is a schematic view of an electronic device according to some example embodiments.

Referring to FIG. 9, an electronic device 900 may include a processor 920 (e.g., a central processing unit or CPU), a memory 930 (e.g., a solid-state drive (SSD) storage device), an additional device 940, and a power supply 950 electrically connected to each other through a bus 910. The additional device 940 may include an electrochromic device 100 as described above (e.g., an electrochromic device 100 according to any of the example embodiments). For example, the additional device 940 may include an optical filter, an electronic signboard, a smart window, a wearable imaging device and/or display device (such as an augmented reality (AR) or a virtual reality (VR) imaging device and/or display device), any combination thereof, or the like, any of which may include an electrochromic device 100 according to any of the example embodiments. In some example embodiments, the additional device 940 may include a processor (e.g., a CPU) and/or a memory (e.g., an SSD). The memory 930 (and/or a memory of the additional device 940), which may be a non-transitory computer readable medium (e.g., an SSD storage device), may store a program of instructions. The processor 920 (and/or a processor of the additional device 940), for example a CPU, may execute the stored program of instructions to perform one or more functions. The power supply 950 may include a rechargeable battery, such as a lithium-ion battery. The processor 920 (and/or a processor of the additional device 940) may be configured to adjustably control a voltage of electrical power (e.g., electrical power supplied from the power supply 950) applied to one or more elements of an electrochromic device 100 of the additional device 940. For example, the processor 920 (and/or a processor of the additional device 940) may be configured to adjustably control a supply of electrical power from the power supply 950 to the additional device 940, for example to adjustably control a voltage applied to an electrochromic device 100 of the additional device 940, to control a color and/or opacity exhibited by at least an electrochromic layer 30 of the electrochromic device 100. The processor 920 (and/or a processor of the additional device 940) may be configured to generate an output (e.g., cause a certain voltage to be applied to the electrochromic layer 30 of the electrochromic device 100 of the additional device 940, to cause the electrochromic device 100 to exhibit a particular color and/or opacity) based on processing a program of instructions stored at the memory 930 (and/or a memory of the additional device 940). In some example embodiments, the additional device 940 may be electrically connected to the power supply 950 independently of a bus 910, and a processor included in the additional device 940 and/or the power supply 950 may be configured to adjustably control the application of voltage to the electrochromic device 100 based on electrical power supplied from the power supply 950. In some example embodiments, one or more of the bus 910, the processor 920, the memory 930, and/or the power supply 950 may be omitted.

The electronic device 900 and/or any portion thereof (e.g., processor 920, memory 930, additional device 940, power supply 950, etc.) may include processing circuitry such as a hardware including logic circuits; a hardware/software combination such as processor-implemented software; or any combination thereof. For example, the processing circuitry may be a central processing unit (CPU), an arithmetic logic unit (ALU), a digital signal processor, a microcomputer, a field programmable gate array (FPGA), System-on-Chip (SoC), a programmable logic unit, a microprocessor, an application-specific integrated circuit (ASIC), or the like. As an example, the processing circuitry may include a non-transitory computer readable storage device. The processor 920 (e.g., a central processing unit or CPU) may, for example, control an operation of the additional device 940 (e.g., an electrochromic device 100 thereof), for example based on executing an instruction program stored at the memory 930 (e.g., a solid-state drive (SSD) storage device).

Hereinafter, some example embodiments are illustrated in more detail with reference to one or more examples. However, the present scope of the inventive concepts is not limited to these one or more examples.

### Example 1

A glass plate coated with FTO (fluorine-doped tin oxide) is washed using an ultrasonic cleaner in water, acetone, and ethanol solvents and then dried in an oven at 70° C. to prepare a transparent FTO electrode.

Subsequently, tungsten oxide nanoparticles are formed on a transparent FTO electrode by a dry powder stacking method. In detail, tungsten oxide powders (source powders) are scanned twice on a transparent FTO electrode at a nozzle scan rate of 80 μm/s, and the gap between the transparent FTO electrode and the nozzle is set to 3 mm and the bed flow is set to 27.5 L/min.

5 wt % DMSO is added to PEDOT:PSS and stirred at 600 rpm for more than 30 minutes at room temperature to prepare a PEDOT:PSS solution. Next, 150 μl of PEDOT:PSS solution is coated on the tungsten oxide nanoparticles, left at room temperature for more than 30 minutes, and then spin-coated at 3000 rpm for 60 seconds and 500 rpm for 30 seconds. Next, a first heat treatment is performed on a hot plate at 130° C. for 30 minutes to form a tungsten oxide nanoparticles thin film thickly covered with PEDOT:PSS.

Next, 100 μl of DMSO is coated on the PEDOT:PSS, left at room temperature for 8 minutes, and then spin-coated at 1000 rpm for 60 seconds to perform a DMSO rinsing process. Next, a second heat treatment is performed on a hot plate at 120° C. for 10 minutes to form a tungsten oxide nanoparticles-PEDOT:PSS thin film (electrochromic layer) from which a significant portion of the PEDOT:PSS thin film is removed.

Separately, ATO nanoparticles are formed on a transparent FTO electrode by a dry powder stacking method to form an ion storage layer.

Then, the tungsten oxide nanoparticles-PEDOT:PSS thin film and the ion storage layer are placed facing each other and sealed, and then 1 M LiClO₄ liquid electrolyte (solvent: 80 ml of propylene carbonate, 105.68 g of ethylene carbonate) is injected between them, manufacturing an electrochromic device.

### Comparative Example 1

An electrochromic device is manufactured in the same manner as in the Example 1, except that the DMSO rinsing process is omitted and a tungsten oxide nanoparticles thin film thickly covered with PEDOT:PSS is used as the electrochromic layer.

### Comparative Example 2

An electrochromic device is manufactured in the same manner as in the Example 1, except that a tungsten oxide nanoparticles thin film is used as the electrochromic layer without PEDOT:PSS.

### Evaluation I

The electrochromic characteristics of electrochromic devices according to Example 1 and Comparative Examples 1 and 2 are evaluated.

The electrochromic characteristics are evaluated by configuring a cycle in which-2.7 V is applied for 60 seconds to achieve coloration mode and 3.0 V is applied for more than 300 seconds to achieve bleaching mode using a potentiostat (Versa STAT4, Applied Research), and the color change over time is evaluated by measuring the transmittance in the 850 nm wavelength range using an ultraviolet-visible spectrometer (UV-VIS spectroscopy, V-770 Jasco).

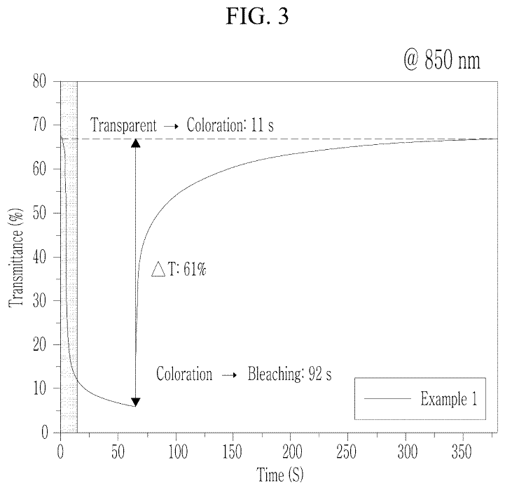

The results are as shown in FIGS. 3 to 5.

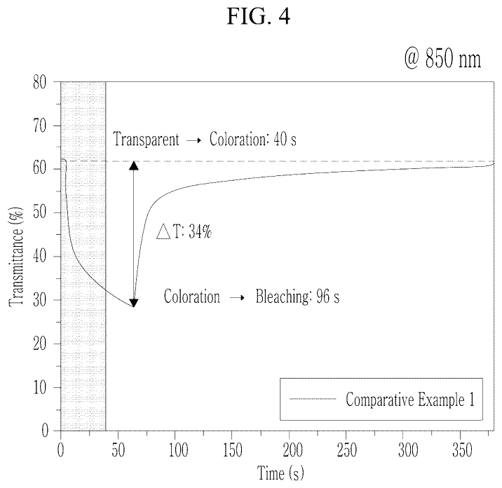

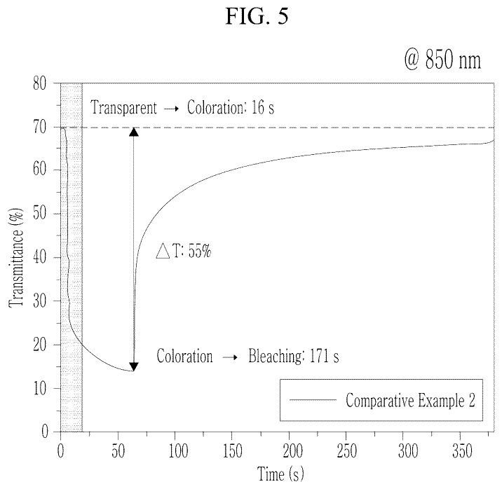

FIG. 3 is a graph showing the color change characteristics of an electrochromic device according to Example 1, FIG. 4 is a graph showing the color change characteristics of an electrochromic device according to Comparative Example 1, and FIG. 5 is a graph showing the color change characteristics of an electrochromic device according to Comparative Example 2.

Referring to FIG. 3, the electrochromic device according to Example 1 has a transmittance change rate of about 61% at a wavelength of 850 nm, the time required for the transmittance change rate to decrease by 90% is 11 seconds, and the time required for the transmittance of the colored device to be bleached by 90% and to recover the transmittance is 92 seconds.

In contrast, referring to FIGS. 4 and 5, the electrochromic device according to Comparative Example 1 has a transmittance change rate of about 34% at a wavelength of 850 nm, the time required for the transmittance change rate to decrease by 90% of 40 seconds, and the time required for the transmittance change rate of the colored device to be bleached by 90% and to recover the transmittance of 96 seconds, and the electrochromic device according to Comparative Example 2 has a transmittance change rate of about 55% at a wavelength of 850 nm, the time required for the transmittance change rate to decrease by 90% of 16 seconds, and the time required for the transmittance change rate of the colored device to be bleached by 90% and to recover the transmittance of 171 seconds.

From this, it may be confirmed that the electrochromic device according to Example 1 has improved reaction speed and color change/bleaching efficiency compared to the electrochromic device according to Comparative Examples 1 and 2.

### Evaluation II

The charge transfer resistance (R_{ct}) characteristics of the electrochromic layer of the electrochromic device according to Example 1 and Comparative Example 1 are evaluated.

Charge transfer resistance characteristics are evaluated using electrochemical impedance spectroscopy (EIS).

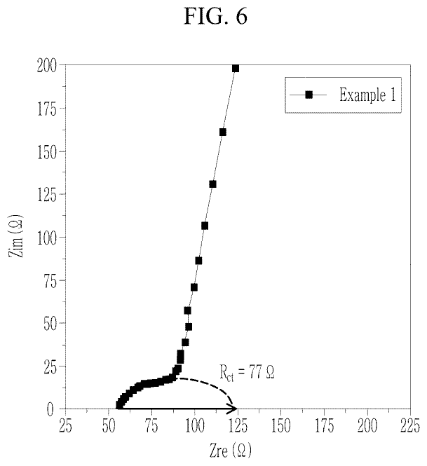

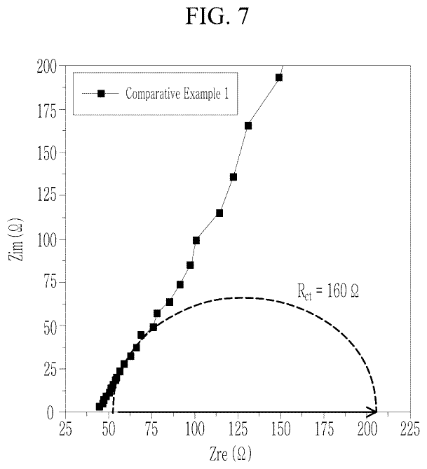

The results are shown in FIGS. 6 and 7.

FIG. 6 is a graph showing the charge transfer resistance characteristics of an electrochromic layer in an electrochromic device according to Example 1 and FIG. 7 is a graph showing the charge transfer resistance characteristics of the electrochromic layer in the electrochromic device according to Comparative Example 1.

Referring to FIGS. 6 and 7, the charge transfer resistance of the electrochromic layer of the electrochromic device according to Example 1 is about 770, and the charge transfer resistance of the electrochromic layer of the electrochromic device according to Comparative Example 1 is about 1600, confirming that the charge transfer resistance of the electrochromic layer in the electrochromic device according to Example 1 is lower than the charge transfer resistance of the electrochromic layer in the electrochromic device according to Comparative Example 1.

### Evaluation III

The sheet resistance of the electrochromic layer of the electrochromic device according to Example 1 and Comparative Example 1 is evaluated using a 4-point probe (CMT-SR2000N, Chang Min Tech Co.).

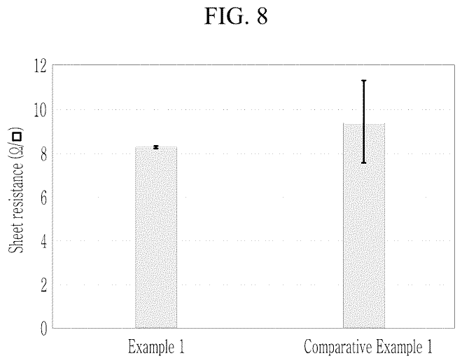

FIG. 8 is a graph showing the surface resistance characteristics of the electrochromic layer in the electrochromic device according to Example 1 and Comparative Example 1.

Referring to FIG. 8, the sheet resistance of the electrochromic layer in the electrochromic device according to Example 1 is constantly about 8.28 Ω/sq. (Ω/□), whereas the sheet resistance of the electrochromic layer in the electrochromic device according to Comparative Example 1 has a large sheet resistance deviation centered around about 9.40 Ω/sq.

From this, the electrochromic layer of the electrochromic device according to Example 1 has a low and uniform surface resistance compared to the electrochromic layer of the electrochromic device according to Comparative Example 1.

While the inventive concepts have been described in connection with what is presently considered to be practical example embodiments, it is to be understood that the inventive concepts are not limited to such example embodiments. On the contrary, the scope of the inventive concepts is intended to cover various modifications and equivalent arrangements included within the spirit and scope of the appended claims.

What is claimed is:

1. An electrochromic device, comprising
a first electrode;
an electrochromic layer on the first electrode;
an electrolyte on the electrochromic layer; and
a second electrode on the electrolyte,
wherein the electrochromic layer includes
inorganic nanoparticles having different particle size distributions along a thickness direction of the electrochromic layer, and
a conductive polymer filling between the inorganic nanoparticles and covering an upper portion of the inorganic nanoparticles, and
wherein a thickness of the conductive polymer covering the upper portion of the inorganic nanoparticles is less than about 10% of a total thickness of the electrochromic layer.

2. The electrochromic device of claim 1, wherein
the electrochromic layer has
a first surface proximate to the first electrode and distal from the electrolyte, and
a second surface proximate to the electrolyte and distal from the first electrode, and
a particle size of the inorganic nanoparticles gradually increases from the first surface of the electrochromic layer to the second surface of the electrochromic layer.

3. The electrochromic device of claim 1, wherein
the electrochromic layer comprises
a first region proximate to the first electrode and distal from the electrolyte, and
a second region proximate to the electrolyte and distal from the first electrode, such that the second region is between the first region and the electrolyte,
the inorganic nanoparticles include a first portion of inorganic nanoparticles in the first region and a second portion of inorganic nanoparticles in the second region, and
a particle size of the first portion of inorganic nanoparticles in the first region is smaller than a particle size of the second portion of inorganic nanoparticles in the second region.

4. The electrochromic device of claim 3, wherein the electrochromic layer comprises a polar solvent.

5. The electrochromic device of claim 4, wherein the polar solvent comprises dimethyl sulfoxide (DMSO), dimethylformamide (DMF), acetonitrile, ethanol, methanol, propanol, butanol, ethylene glycol, acetone, 1,2-dichloroethane, or any combination thereof.

6. The electrochromic device of claim 4, wherein the polar solvent is included in the electrochromic layer in an amount of about 0.001 wt % to about 1 wt % based on a total weight of the electrochromic layer.

7. The electrochromic device of claim 1, wherein the inorganic nanoparticles comprise tungsten oxide nanoparticles.

8. The electrochromic device of claim 1, wherein the conductive polymer comprises PEDOT:PSS, polyaniline, polyacetylene, polypyrrole, polythiophene, polyparaphenylene, polyphenylenevinylene, polyfuran, a derivative thereof, or any combination thereof.

9. The electrochromic device of claim 1, wherein a thickness of the conductive polymer covering the upper portion of the inorganic nanoparticles is less than about 30 nm.

10. The electrochromic device of claim 1, further comprising an ion storage layer between the second electrode and the electrolyte, the ion storage layer including antimony-doped tin oxide.

11. An electrochromic device, comprising:
a first electrode and a second electrode facing each other;
an electrochromic layer between the first electrode and the second electrode, the electrochromic layer including a mixture of tungsten oxide nanoparticles and a conductive polymer; and
an electrolyte between the electrochromic layer and the second electrode,
wherein the conductive polymer includes PEDOT:PSS, polyaniline, polyacetylene, polypyrrole, polythiophene, polyparaphenylene, polyphenylenevinylene, polyfuran, a derivative thereof, or any combination thereof,
wherein the electrochromic layer has
a first surface proximate to the first electrode and distal from the electrolyte, and
a second surface proximate to the electrolyte and distal from the first electrode, and
wherein a particle size of the tungsten oxide nanoparticles increases from the first surface of the electrochromic layer to the second surface of the electrochromic layer.

12. The electrochromic device of claim 11, wherein
the electrochromic layer comprises a polar solvent, the polar solvent including dimethylsulfoxide (DMSO), dimethyl formamide (DMF), acetonitrile, ethanol, methanol, propanol, butanol, ethylene glycol, acetone, 1,2-dichloroethane, or any combination thereof, and
the polar solvent is included in the electrochromic layer in an amount of about 0.001 wt % to about 1 wt % based on a total weight of the electrochromic layer.

13. A method of manufacturing an electrochromic device, the method comprising:
forming an electrochromic layer on a first electrode;
disposing a second electrode to face the electrochromic layer; and
supplying an electrolyte between the electrochromic layer and the second electrode,
wherein the forming of the electrochromic layer includes
applying inorganic nanoparticles having different particle size distributions along a thickness direction on the first electrode, the thickness direction extending perpendicular to an upper surface of the first electrode,
supplying a conductive polymer on the inorganic nanoparticles to fill spaces between the inorganic nanoparticles and to coat on an upper portion of the inorganic nanoparticles, and
rinsing the conductive polymer with a polar solvent to remove a portion of the conductive polymer that is on the upper portion of the inorganic nanoparticles.

14. The method of claim 13, wherein the applying of the inorganic nanoparticles comprises dry powder stacking the inorganic nanoparticles on the first electrode in a chamber.

15. The method of claim 14, wherein
the dry powder stacking the inorganic nanoparticles comprises supersonically spraying the inorganic nanoparticles from a nozzle through a pressure difference between the chamber and a cartridge including the inorganic nanoparticles in a form of an aerosol powder, and
a particle size of a first portion of the inorganic nanoparticles that are sprayed and stacked on the upper surface of the first electrode is smaller than a particle size of a second portion of the inorganic nanoparticles that are sprayed and stacked on the first portion of the inorganic nanoparticles, subsequent to the spraying and stacking of the first portion of the inorganic nanoparticles.

16. The method of claim 13, further comprising:
performing a first heat treatment subsequent to supplying the conductive polymer, and
performing a second heat treatment subsequent to rinsing the conductive polymer with the polar solvent,
wherein the first heat treatment and the second heat treatment are independently performed at about 80° C. to about 200° C.

17. The method of claim 16, wherein
subsequent to the first heat treatment and prior to the second heat treatment, the conductive polymer on the upper portion of the inorganic nanoparticles has a first thickness, and
subsequent to the second heat treatment, the conductive polymer on the upper portion of the inorganic nanoparticles has a second thickness, the second thickness thinner than the first thickness.

18. The method of claim 17, wherein the second thickness of the conductive polymer is less than about 10% of a total thickness of the electrochromic layer.

19. The method of claim 16, wherein electrical conductivity of the electrochromic layer subsequent to the second heat treatment is higher than electrical conductivity of the electrochromic layer subsequent to the first heat treatment and prior to the second heat treatment.

20. An electronic device comprising the electrochromic device of claim 1.
